(19) United States
(12) Patent Application Publication
(10) Pub. No.: US 2010/0178390 A1
(43) Pub. Date: Jul. 15, 2010

(54) Micronutrient-Simulated Beverages

(75) Inventors: A. Reza Kamarei, Apopka, FL (US); Kathleen Drozdowski, Altamonte Springs, FL (US)

Correspondence Address: THE COCA-COLA COMPANY;PATENT & TECHNOLOGY DEPT--NAT 19, P. O. BOX 1734, ATLANTA, GA, 30301, US

(73) Assignee: THE COCA-COLA COMPANY, Atlanta, GA (US)

(21) Appl. No.: 12/351,265

(22) Filed: Jan. 9, 2009

(51) Int. Cl. A23L 2/52

(52) U.S. Cl. 426/72

(57) ABSTRACT

A simulated beverage simulating a natural juice, the simulated beverage comprising, per serving, at least about an equal amount of all micronutrients that are present in an amount of at least about 10% of the recommended Daily Value (“DV”) per serving of the natural juice, wherein the simulated beverage is substantially free of the natural juice and organoleptically similar to the natural juice.

### FIELD OF INVENTION

This invention relates generally to simulated beverages and more particularly to simulated juice beverages with similar micronutrient profiles as natural juices.

### BACKGROUND

The United States Food and Drug Administration (“FDA”) has established a recommended Daily Value (“DV”) for certain nutrients based upon a 2,000 kcal/day diet for adults and children four years and older. (Code of Federal Regulations; 21 CFR §101.9). Foods and beverages that provide at least about 10% of the recommended DV per serving may be labeled as a “good source” of the nutrient. Foods and beverages that are labeled “excellent sources” of a nutrient provide at least about 20% of the recommended DV per serving.

Natural juices have long been recognized as valuable sources of micronutrients. The term “micronutrient” as used herein includes sodium, potassium, vitamin A, vitamin C, calcium, iron, vitamin D, vitamin E, vitamin K, thiamin, riboflavin, niacin, vitamin B6, folate, vitamin B12, biotin, pantothenic, phosphorous, iodine, magnesium, zinc, selenium, copper, manganese, chromium, molybdenum, and chloride. Juices identified as containing about 100% of natural orange juice typically contain, per serving, more than 10% of the recommended DV of potassium, vitamin C, thiamin, and folate. The term “serving” as used herein refers to 8 fluid ounces.

Despite the nutritional benefits of natural juices, high production costs and limited resources can often drive up their prices, making them less accessible for some members of the global population, who nevertheless are still in need of the same micronutrients. Although there are cheaper substitutes to 100% natural juices in the market, they do not provide similar micronutrient profiles and/or organoleptic properties as natural juices. The term “similar” is understood to also include “identical.” Thus, there exists a need for a simulated beverage that is substantially free of natural juicers) but has similar micronutrient profiles.

### SUMMARY OF THE INVENTION

The present disclosure encompasses a simulated beverage simulating a natural juice; the simulated beverage comprising, per serving, at least about an equal amount of all micronutrients that are present in an amount of at least about 10% of the recommended DV per serving of the natural juice, wherein the simulated beverage is substantially free of the natural juice and organoleptically similar to the natural juice.

The present disclosure also encompasses a simulated beverage simulating a natural juice; the simulated beverage comprising, per serving, at least about an equal amount of all micronutrients other than folate that are present in an amount of at least about 10% of the recommended DV per serving of the natural juice, wherein the simulated beverage is substantially free of the natural juice and organoleptically similar to the natural juice.

The present disclosure also encompasses a method for making a simulated beverage comprising a) selecting a natural juice, b) identifying all micronutrients other than folate that are present in an amount of at least 10% of the recommended DV per serving of the natural juice, c) measuring the amount of all said micronutrients per serving of the natural juice, and d) producing a simulated beverage comprising, per serving, at least about an equal amount of all said identified and measured micronutrients of the natural juice, wherein the simulated beverage is substantially free of the natural juice and organoleptically similar to the natural juice.

Other objects, features, and advantages of this invention will be apparent from the following detailed descriptions and claims.

### DETAILED DESCRIPTION OF THE INVENTION

As summarized above, embodiments of the present invention encompass a simulated beverage simulating a natural juice; the simulated beverage comprising, per serving, at least about an equal amount of all micronutrients that are present in an amount of at least about 10% of the recommended DV per serving of the natural juice, wherein the simulated beverage is substantially free of the natural juice and organoleptically similar to the natural juice.

As used herein, the term “natural juice” refers to single-strength juices that derive either from diluting natural juice concentrates with water or directly from at least one fruit, at least one vegetable, and combinations thereof.

As used herein, the term “citrus juice” refers to fruit juices selected from orange juice, lemon juice, lime juice, grapefruit juice, tangerine juice, and combinations thereof.

As used herein, the term “organoleptically similar” is defined as evoking similar responses from one or more of the organs of special sense, i.e. taste, smell, etc.

In a particular embodiment, the natural juice of the present invention may be a citrus juice. In a more particular embodiment, the natural juice may be an orange juice and such, the simulated beverage may comprise, per serving, at least about 13% of the recommended DV of potassium, at least about 120% of the recommended DV of vitamin C, at least about 10% of the DV of thiamin, and at least about 15% of the recommended DV of folate. In an alternative embodiment, the natural juice may be a pineapple juice and such, the simulated beverage may comprise, per serving, at least about 42% of the recommended DV of vitamin C, at least about 10% of the recommended DV of thiamin, at least about 13% of the recommended DV of vitamin B6, and at least about 15% of the recommended DV of folate.

In a particular embodiment, the natural juice may also be a grapefruit juice and such, the simulated beverage may comprise, per serving, at least about 11% of the recommended DV of potassium and at least about 120% of the recommended DV of vitamin C. In an alternative embodiment, the natural juice may also be a pomegranate juice and such, the simulated beverage may comprise, per serving, at least about 12% of the recommended DV of potassium.

According to a particular embodiment, the natural juice may be a carrot juice and such, the simulated beverage may comprise, per serving, at least about 903% of the recommended DV of vitamin A, at least about 33% of the recommended DV of vitamin C, at least about 14% of the recommended DV of thiamin, at least about 26% of the recommended DV of vitamin B6, at least about 46% of the recommended DV of vitamin K, and at least about 14% of the recommended DV of vitamin E. In an alternative embodiment, the natural juice may be a tomato juice and such, the simulated beverage may comprise, per serving, at least about 16% of the recommended DV of potassium, at least about 22% of the recommended DV of vitamin A, and at least about 74% of the recommended DV of vitamin C. In another alternative embodiment, the natural juice may be a cranberry juice and such, the simulated beverage may comprise, per serving, at least about 178% of the recommended DV of vitamin C.

The science on the micronutrient folate continues to evolve and it is unsettled today as to how much folate, if any, should be added to a food product. In a particular embodiment, the simulated beverage may comprise, per serving, at least about an equal amount of all micronutrients other than folate that are present at an amount of at least about 10% of the recommended DV in the natural juice, wherein the simulated beverage is substantially free of the natural juice and organoleptically similar to the natural juice. In a more particular embodiment, the natural juice may be an orange juice and such, the simulated beverage may comprise, per serving, at least about 13% of the recommended DV of potassium, at least about 120% of the recommended DV of vitamin C, and at least about 10% of the recommended DV of thiamin. In an alternative embodiment, the natural juice may be a pineapple juice and such, the simulated beverage may comprise, per serving, at least about 42% of the recommended DV of vitamin C, at least about 10% of the recommended DV of thiamin, and at least about 13% of the recommended DV of vitamin B6.

The simulated beverage of the present invention may be provided in a variety of forms that depends on factors such as beverage application, packaging and shipping costs, and market needs. Such forms may include, but are not limited to, reconstituted, ready-to-drink, and the like.

Optional additives may be added to the simulated beverage to simulate the organoleptic properties of a natural juice. Those of ordinary skill in the art can readily determine the identity and quantity of such additives depending on the natural juice selected for simulation. In one embodiment, the simulated beverage may comprise at least one food-grade additive. In a more particular embodiment, the at least one food-grade additive may be selected from a flavorant, a cloudifier, a colorant, a thickening agent, a nutrient other than a micronutrient, and combinations thereof

Embodiments of the present invention may also encompass a method for making a simulated beverage comprising the steps of: (a) selecting a natural juice, (b) identifying all micronutrients other than folate that are present in an amount of at least about 10% of the recommended DV per serving of the natural juice, (c) measuring the amount of all said identified micronutrients per serving of the natural juice; and (d) producing a simulated beverage comprising, per serving, at least about an equal amount of said identified and measured micronutrients of the natural juice, wherein the simulated beverage is substantially free of the natural juice and organoleptically similar to the natural juice. Steps (b) and (c) may occur simultaneously. In a more particular embodiment, the micronutrients comprise folate.

In addition to the micronutrients, natural juices also contain phytonutrients, such as flavonoids. To study the effect of these phytonutrients in a natural juice without interfering effects from differences in micronutrients, a placebo beverage that comprises similar micronutrient profiles as the natural Juice but no phytonutrients may be used. In a particular embodiment of the present invention, the simulated beverage may comprise less than about one mg of a phytonutrient in about one kg of beverage. In a more particular embodiment, the phytonutrient may be selected from hesperidin, narirutin, didymin, sinensetin, hexamethoxyflavnone, nobiletin, scutellarein TME, heptamethoxyflavone, tangeretin, limonin glucoside, limonin, and combinations thereof.

Embodiments of the present invention may also encompass the use of the simulated beverage as a placebo in a clinical trial wherein, the clinical trial may be used to study the effect of at least one naturally-occurring phytonutrient in a natural juice on at least one clinical parameter. The term “clinical parameter,” as used herein, refers to any aspect of an entity that can be measured or perceived without changing its identity. An example of such a clinical parameter may include, but is not limited to, blood antioxidant level and blood pressure.

The invention is further illustrated by the following example, which is not to be construed in any way as imposing limitations on the scope thereof. On the contrary, it is to be clearly understood that resort may be had to various other embodiments, modifications, and equivalents thereof which, after reading the description herein, may suggest themselves to those skilled in the art without departing from the spirit of the present invention and/or scope of the appended claims.

### EXAMPLE I

In this example, a natural orange juice was selected for simulation. The natural orange juice contained more than 10% of the recommended DV per serving of four micronutrients, specifically potassium, vitamin C, thiamin, and folate. (Table 1, Left column) After the amounts of these micronutrients were measured, a formula comprising these four micronutrients was developed to produce a simulated beverage with similar or greater levels of these micronutrients per serving. Additional ingredients were added to simulate the organoleptic properties of the natural orange juice. Table 2 shows the final formula used for making a four-liter simulated orange juice using non-citrus sources of ingredients. The ingredients were blended together, allowing ample time for the pectin to hydrate and to be homogenized at 3,000 psi. The mixture was then pasteurized at 177° F. for about two to about five seconds and then filled at 35° F. to obtain the simulated beverage.

TABLE 1

| Natural | | Micronutrients Simulated | |
|---|---|---|---|
| Orange Juice (from concentrate) | | Orange Juice (values ± 5%) | |
| Nutrition Facts | | Nutrition Facts | |
| Serving Size 8 fl oz (240 ml) | | Serving Size 8 fl oz (240 ml) | |
| Amount Per Serving | | Amount Per Serving | |
| Calories 110 Cal from Fat 0 | | Calories 121 Cal from Fat 0 | |
| | % | | % |
| | D.V.* | | D.V.* |
| Total Fat 0 g | 0% | Total Fat 0 g | 0% |
| Saturated Fat 0 g | | Saturated Fat 0 g | |
| Trans Fat 0 g | | Trans Fat 0 g | |
| Cholesterol 0 mg | 0% | Cholesterol 0 mg | 0% |
| Sodium 15 mg | 1% | Sodium 6 mg | 0% |
| Potassium 450 mg | 13% | Potassium 374 mg | 11% |
| Total Carbohydrate 27 g | 9% | Total Carbohydrate 30.2 g | 10% |
| Dietary Fiber 0 g | 0% | Dietary Fiber 0 g | 0% |
| Sugars 24 g | | Sugars 25.44 g | |
| Protein 2 g | 4% | Protein 0 g | 0% |
| Vitamin A | 0% | Vitamin A | 0% |
| Vitamin C | 120% | Vitamin C | 193% |
| Calcium | 2% | Calcium | 3% |
| Iron | 0% | Iron | 0% |
| Thiamin (Vit. B1) | 10% | Thiamin (Vit. B1) | 13% |
| Riboflavin | 0% | Riboflavin | 0% |
| Niacin | 2% | Niacin | 2% |
| Vitamin B6 | 4% | Vitamin B6 | 4% |
| Folate | 15% | Folate | 19% |
| Magnesium | 6% | Magnesium | 4% |

*Percent Daily Values (DV) are based on a 2,000 calorie diet.

TABLE 2

| Ingredient | Source | Quantity (g) |
|---|---|---|
| Sucrose | Dixie Crystals | 197.44 |
| HFCS-55 | TCCC | 348.80 |
| Tricalcium Phosphate | Innophos | 0.864 |
| Ascorbic Acid | Tate & Lyle | 1.6 |
| Magnesium Oxide | EMD | 0.613 |
| Potassium Citrate | Tate & Lyle | 23.23 |
| Thiamine Hydrochloride (B1) | DSM | 0.0025 |
| Niacinamide (B3) | DSM | 0.00667 |
| Folic Acid | DSM | 0.001 |
| Pyridoxine Hydrochloride (B6) | DSM | 0.00087 |
| Water | Zephyrhills | 3529.86 |
| Citric Acid | Jiangsu Jiangshan | 32.25 |
| | Pharmaceutical Co LTD | |
| Neutral Cloud | TCCC | 1.64 |
| Pectin | Martek | 8.00 |
| FD&C Yellow #6 | Warner Jackson | 0.0321 |
| FD&C Yellow #5 | Sensient | 0.028 |

The simulated orange juice was tested for micronutrients and compared to the micronutrients of the natural orange juice. The results are shown in Table 1. The natural orange juice contained more than 10% of the recommended DV for potassium, vitamin C, thiamin, and folate. The simulated orange juice, which was substantially free of any natural juice, also contained more than 10% of the recommended DV for these same micronutrients. Specifically, the simulated orange juice contained greater percentages of vitamin C, thiamin, and folate than the natural orange juice. Under the current formula, the potassium level of the simulated orange juice was lower than the level found in the natural orange juice. However, one of ordinary skill in the art can readily adjust the formula so that the simulated juice would have a potassium level at least equal or greater than the natural juice.

It should be understood that the foregoing relates to particular embodiments of the present invention, and that numerous changes may be made therein without departing from the scope of the invention as defined from the following claims.

1. A simulated beverage simulating a natural juice, the simulated beverage comprising, per serving,
at least about an equal amount of all micronutrients that are present in an amount of at least about 10% of the recommended Daily Value (“DV”) per serving of the natural juice,
wherein the simulated beverage is substantially free of the natural juice and organoleptically similar to the natural juice.

2. The simulated beverage of claim 1, wherein the natural juice is selected from at least one fruit juice, at least one vegetable juice, and a combination thereof.

3. The simulated beverage of claim 1, wherein the natural juice is a citrus juice.

4. The simulated beverage of claim 1, wherein the natural juice is an orange juice and the simulated beverage comprises, per serving,
at least about 13% of the recommended DV of potassium;
at least about 120% of the recommended DV of vitamin C;
at least about 10% of the recommended DV of thiamin; and
at least about 15% of the recommended DV of folate.

5. The simulated beverage of claim 1, wherein the natural juice is a pineapple juice and the simulated beverage comprises, per serving,
at least about 42% of the recommended DV of vitamin C;
at least about 10% of the recommended DV of thiamin;
at least about 13% of the recommended DV of vitamin B6; and
at least about 15% of the recommended DV of folate.

6. The simulated beverage of claim 1, wherein the natural juice is a grapefruit juice and the simulated beverage comprises, per serving,
at least about 11% of the recommended DV of potassium; and
at least about 120% of the recommended DV of vitamin C.

7. The simulated beverage of claim 1, wherein the natural juice is a pomegranate juice and the simulated beverage comprises, per serving, at least about 12% of the recommended DV of potassium.

8. The simulated beverage of claim 1, wherein the natural juice is a carrot juice and the simulated beverage comprises, per serving,
at least about 903% of the recommended DV of vitamin A;
at least about 33% of the recommended DV of vitamin C;
at least about 14% of the recommended DV of thiamin;
at least about 26% of the recommended DV of vitamin B6;
at least about 46% of the recommended DV of vitamin K; and
at least about 14% of the recommended DV of vitamin E.

9. The simulated beverage of claim 1, wherein the natural juice is a tomato juice and the simulated beverage comprises, per serving,
at least about 16% of the recommended DV of potassium;
at least about 22% of the recommended DV of vitamin A; and
at least about 74% of the recommended DV of vitamin C.

10. The simulated beverage of claim 1, wherein the natural juice is a cranberry juice and the simulated beverage comprises, per serving, at least about 178% of the recommended DV of vitamin C.

11. The simulated beverage of claim 1, wherein the simulated beverage is a reconstituted beverage.

12. The simulated beverage of claim 1, wherein the simulated beverage is a ready-to-drink beverage.

13. The simulated beverage of claim 1, wherein the simulated beverage comprises less than about one mg of a phytonutrient in about one kg of beverage.

14. The simulated beverage of claim 13, wherein the phytonutrient is selected from hesperidin, narirutin, didymin, sinensetin, hexamethoxyflavnone, nobiletin, scutellarein TME, heptamethoxyflavone, tangeretin, limonin glucoside, limonin, and a combination thereof.

15. The use of the simulated beverage of claim 1 as a placebo in a clinical trial.

16. A simulated beverage simulating a natural juice, the simulated beverage comprising, per serving
at least about an equal amount of all micronutrients other than folate that are present in an amount of at least about 10% of the recommended Daily Value (“DV”) per serving the natural juice, wherein the simulated beverage is substantially free of the natural juice and organoleptically similar to the natural juice.

17. The simulated beverage of claim 16, wherein the natural juice is an orange juice and the simulated beverage comprises, per serving,
at least about 13% of the recommended DV of potassium;
at least about 120% of the recommended DV of vitamin C; and
at least about 10% of the recommended DV of thiamin.

18. The simulated beverage of claim 16, wherein the natural juice is a pineapple juice and the simulated beverage comprises, per serving,
at least about 42% of the recommended DV of vitamin C;
at least about 10% of the recommended DV of thiamin; and
at least about 13% of the recommended DV of vitamin B6.

19. The use of the simulated beverage of claim 16 as a placebo in a clinical trial.

20. A method for making a simulated beverage comprising:
(a) selecting a natural juice;
(b) identifying all micronutrients other than folate that are present in an amount of at least 10% of the recommended Daily Value (“DV”) per serving of the natural juice;
(c) measuring the amount of all said micronutrients per serving of the natural juice; and
(d) producing a simulated beverage comprising, per serving, at least about an equal amount of all said identified and measured micronutrients of the natural juice, wherein the simulated beverage is substantially free of the natural juice and organoleptically similar to the natural juice.
